(19) United States
(12) Patent Application Publication
(10) Pub. No.: US 2014/0147539 A1
(43) Pub. Date: May 29, 2014

(54) Device for Vulcanizing a Tire Comprising an Inner Reshaping Envelope

(71) Applicant: Marie-Claude Cambon, Beauregard l'Eveque (FR)

(72) Inventors: Nicolas Jeannoutot, Clermont-Ferrand Cedex 9 (FR); Jean-Claude Cambon, Beauregard L'Eveque (FR); Michael Massoptier-David, Clermont-Ferrand Cedex 9 (FR); Jean-Charles Ferrand, Clermont-Ferrand Cedex 9 (FR)

(21) Appl. No.: 13/880,636

(22) PCT Filed: Oct. 6, 2011
(86) PCT No.: PCT/EP2011/067468

§ 371 Date: Dec. 3, 2013

(30) Foreign Application Priority Data
Oct. 19, 2010 (FR) 1058523

(51) Int. Cl. B29D 30/06

(52) U.S. Cl. CPC B29D 30/0654
USPC 425/52

(57) ABSTRACT

A cylindrical vulcanization housing with an axis XX′, formed by a lower pan and an upper pan kept in the closed position during vulcanization, and delimiting an enclosure containing a mould and associated components that delimit a closed internal volume (Vᵢ) configured to receive a heat transfer fluid at a pressure P₁, the projection of said internal volume (Vᵢ) on a plane perpendicular to the axis XX′ forming a surface whose area is S₁. A reshaping envelope (3), configured to receive a fluid at a pressure P₂ is positioned axially between the axially outer walls of the mould parts and the vulcanization pan, the projection of said volume of said reshaping envelope on a plane perpendicular to the axis XX′ delimiting a surface with an area S₂, such that S₂*P₂ is greater than S₁*P₁.

The invention relates to the field of the vulcanization of tires, and is more particularly concerned with vulcanization devices.

Conventionally, a device of this kind is formed by a pan or a press comprising a lower pan and an upper pan or lid, which serve to contain the mould and keep it in a closed position for the duration of the vulcanization. As a general rule, the mould is connected to the press by two flat surfaces, more commonly referred to as plates.

The mould, which is specific to one size of tire, is formed by the assembly of parts intended to be brought into contact with the tire to be vulcanized, and comprises lower and upper shells intended to mould the sidewall areas, lower and upper bead rings intended to mould the beads and the lower area of the sidewalls, and a set of sectors carrying the impression of the tread, which are radially movable by the action of a clamping ring.

The inner walls of the mould parts define an internal volume intended to be brought into contact with the unvulcanized green tire. Inside the tire, a pressurized heat transfer fluid is used to apply pressure and press the green tire against the inner walls of the mould, and also to supply the thermal energy required for vulcanization. Heating devices may also be provided between the mould parts and the pan, in order to keep the mould at the desired temperature.

As a general rule, a curing membrane is fitted in the central inner part between two plates, namely a lower and an upper plate, and is deployed under the effect of the pressure of the heat transfer fluid so as to be interposed between said heat transfer fluid and the radially inner part of the tire.

A locking means is used to keep the pan in the closed position during the vulcanization. In this conventional configuration, the mould is pre-stressed by the press before the internal pressure is applied. Thus, during the increase in pressure, the mould does not open, provided that this pressure does not give rise to forces which exceed the pre-stressing forces.

The internal pressure may generate forces of the order of 100 tonnes for a passenger vehicle tire and more than 250 tonnes for a heavy goods vehicle tire, and the forces may exceed several thousand tonnes for a tire of a civil engineering vehicle.

The vulcanization pan interacts with the set of devices intended to provide and support the movements of the mould parts, so as to allow the opening and closing of the pan and the mould during the tire insertion and removal operations before and after the vulcanization stage. These movement devices also serve to exert the pre-stressing forces on each of the mould parts. Thus, conventionally, each pan, or pair of pans, includes the set of movement means, and remains fixed at a given location.

However, it has been observed that some of these means are inactive during vulcanization. With the aim of reducing the amount of investment required to construct a curing workshop, recent technological developments have led to the construction of container-type vulcanization devices, in which a housing containing the mould and tire is moved as required towards a fixed operating station which has actuators intended to carry out the operations of opening and closing the housing and mould and removing and inserting tires.

When closed, the housing is connected solely to means for regulating the mould temperature and keeping the internal volume under pressure, and it can then be transferred independently towards a dedicated location, remote from the operating means, for the duration of the vulcanization process itself.

Various types of housing have been developed by manufacturers. In a first type, the housing includes two massive plates connected by columns having a sufficient cross section to reproduce the clamping functions of a conventional press. The mould is pre-stressed by the elongation of the columns. This type of housing, which is relatively heavy, has the drawback of requiring powerful actuators to apply the pre-stressing forces during closing.

In a second type, the housing is not pre-stressed, and is locked by the internal pressure generated by the heat transfer fluid. This type of housing is known as a self-locking housing. This type of arrangement causes the internal pressure, used to open the mould parts with respect to each other, to be transferred to mechanical locking and clamping means which can keep the housing and the mould in the closed position and increase the clamping forces in proportion to the increase in internal pressure throughout the vulcanization period. The opening and closing means are thus reduced and are used only for handling the components of the housing and the mould, without the need to provide large clamping forces.

However, if there is no pre-stressing, the internal pressure causes elastic deformation of the parts of the housing and the mould, making it impossible to eliminate all the clearances that may appear between the different parts of the mould. This leads to harmful movements of the mould parts with respect to one another, and may result in undesirable changes in the quality and geometry of the tire.

The object of the invention is to provide an original solution to this problem.

According to the invention, the vulcanization device comprises a cylindrical vulcanization housing with an axis XX′, formed by a lower pan and an upper pan which are movable axially with respect to one another. This device further comprises means for locking the lower and upper pans, these means being adapted to keep said lower and upper pans in the closed position during vulcanization. The pan delimits an enclosure, containing:
a mould whose inner walls are intended to come into contact with the tire, and
a lower plate and an upper plate which come to bear, respectively, on the radially inner regions of the mould parts which are intended to mould the upper and lower beads of said tire when the pan is in the closed position, in such a way that, when the pan is in the closed position, the inner walls of the mould and of the upper and lower plates define a closed internal volume intended to receive a heat transfer fluid at a pressure P₁, the projection of said internal volume on a plane perpendicular to the axis XX′ forming a surface with the area S₁.

The device according to the invention is characterized in that a reshaping envelope intended to receive a fluid at a pressure P₂, comprising a wall which is movable axially under the action of said fluid, is positioned axially between the axially outer walls of the mould parts and the vulcanization pan, the projection of said volume of said reshaping envelope on a plane perpendicular to the axis XX′ delimiting a surface with an area S₂ such that S₂*P₂ is greater than S₁*P₁, in such a way that, when the device is locked and pressurized, the movable wall exerts on the mould parts an axial force greater than the resultant of the axial forces which are exerted by the heat transfer fluid on the mould parts and which tend to cause the axial opening of the parts of said mould.

By pressurizing the reshaping envelope it is possible to oppose the axial forces generated by the pressurized heat transfer fluid and to take up all the clearances between the mould parts which may appear during this phase of vulcanization. This arrangement also makes it possible to break the mechanical link between the handling means and the housing for the duration of the vulcanization of the tire.

Advantageously, the walls of the reshaping envelope are formed by a flexible membrane with a surface area S₂, thereby allowing the axial movement of the wall of the envelope that is in contact with the mould parts.

Alternatively, the walls of the reshaping envelope may be formed by rigid walls forming an annular chamber in which a movable wall with a surface area S₂ moves axially.

It may also be advantageous to choose a reshaping envelope for which the surface area S₂ is greater than the surface area S₁, making it possible to use a lower pressure P₂, preferably equal to the pressure P₁. The heat transfer fluid can then be introduced simultaneously, at the same pressure P, into the internal volume of the tire and into the reshaping envelope.

In a known way, the mould may comprise:
a lower shell and bead ring and an upper shell and bead ring, intended to mould the sidewalls and beads of the tire, and adapted to move towards each other axially,
a plurality of circularly distributed sectors, carrying the impression intended to mould the tread and adapted to be moved radially and, when the pan is in the closed position, to come into contact with the lower and upper shells as the segments move in the radially inward direction.

In the present case, the sectors move radially under the action of at least one circular clamping ring, which moves integrally with the lower pan and/or the upper pan, and which interacts with the radially outer faces of said sectors.

It is advantageous, in this case, to position the reshaping envelope axially between the pan and the axially outer face of a ring, in such a way that the axial force exerted by the movable wall of the reshaping envelope on said ring when the fluid contained by said reshaping envelope is brought to the pressure P₂ exerts an additional radial clamping force on said sectors.

Similarly, a heating plate, on which a sector clamping ring, a shell and a bead ring are fixed, may be placed between the mould and the reshaping envelope. In this case, the reshaping envelope is placed between the axially outer wall of the heating plate and the pan.

In a known way, a flexible resilient membrane of substantially cylindrical shape may be fixed by its two axial edges to the lower and upper plates so as to be interposed between the inner surface of the tire and the heat transfer fluid.

Finally, if the upper plate is carried by an operating shaft whose cross section perpendicular to the axis XX′ has an area S₃, and if the operating shaft passes through the internal volume intended to receive the heat transfer fluid, the cross section S₃ is advantageously subtracted from the projection on a plane perpendicular to the axis XX′ of the internal volume containing the pressurized heat transfer fluid.

The following description refers to an exemplary embodiment of the invention, and to FIGS. 1 to 3, in which:

FIG. 1 is a sectional view of a device according to the invention in the semi-open position,

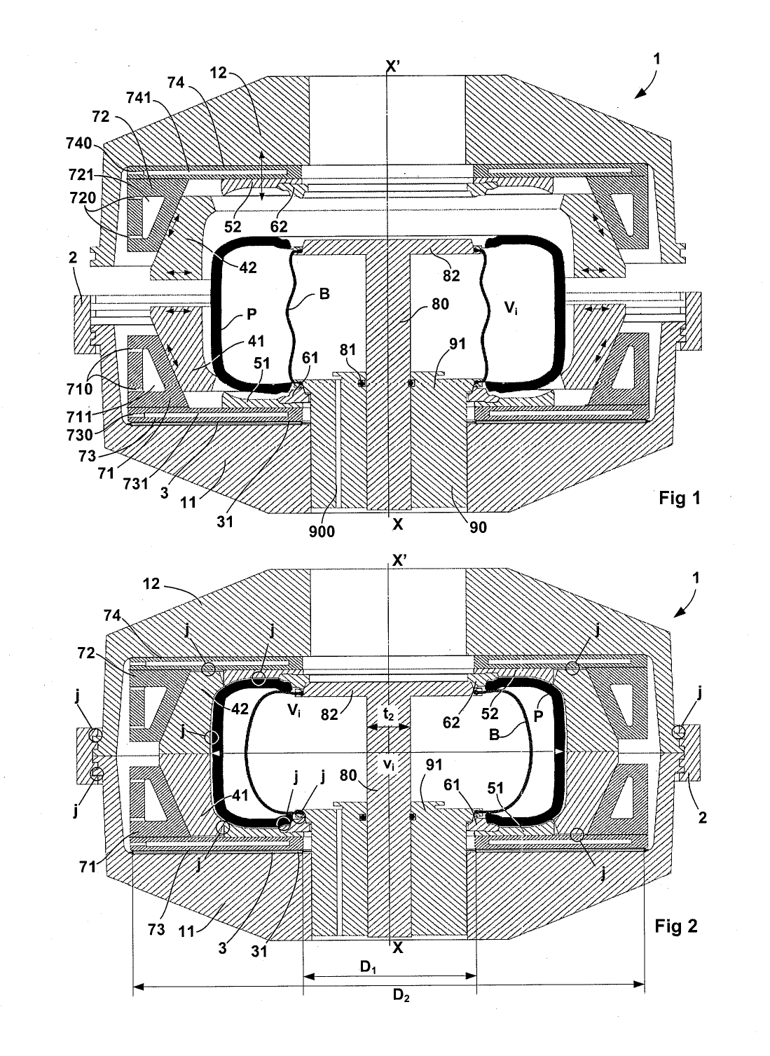

FIG. 2 shows the same device in the locked and closed position, in which the reshaping envelope is not pressurized, resulting in the appearance of the principal clearances between the parts of the mould,

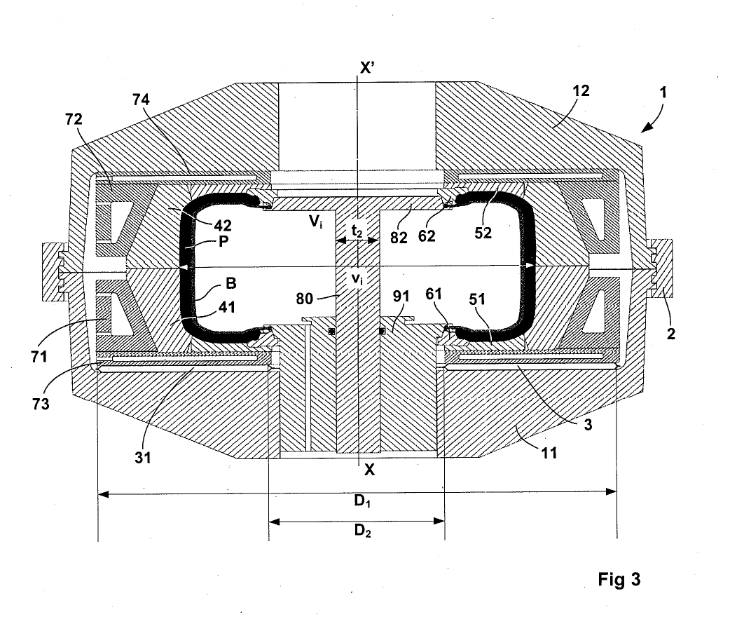

FIG. 3 shows the device of FIG. 2 after the reshaping envelope has been pressurized.

The vulcanization device 1 shown in a semi-open configuration in FIG. 1 is a device of the container type comprising a circular vulcanization pan comprising a lower pan 11 and an upper pan 12. These two pans are axially movable with respect to one another along the axis XX′. A locking means 2 which is rotatable about the axis XX′ allows the lower pan and the upper pan to be kept in the closed position during the vulcanization.

The axial movement of the pans and the rotary movement of the locking means are produced mechanically by operating means (not shown).

The mould placed inside the pan comprises a lower shell 51 and an upper shell 52, intended to mould the lower sidewall and the upper sidewall of a tire P respectively, together with a lower bead ring 61 and an upper bead ring 62, intended to mould the lower bead and the upper bead of said tire respectively. The lower shell 51 and the lower bead ring 61 are made to move integrally with the lower pan 11, and the upper shell 52 and the bead ring 62 are fixed to the upper pan 12.

A plurality of sectors carrying the impression of the tread are distributed circularly about the axis XX′. In the case of the device which is the subject of the present description, the sectors comprise a set of lower sectors 41 which move integrally with the lower pan, and a set of upper sectors 42 which move integrally with the upper pan.

Each set of sectors is supported by a lower clamping ring 71 and an upper clamping ring 72, which are integral, respectively, with the lower pan 11 and the upper pan 12. The radially inner face of each of the clamping rings forms a specified angle with the axial direction. Each sector is connected to the ring by means of a slide (not shown) placed at the intersection of a radial plane with the radially inner face of the ring, in which said sector can move freely under the action of a return spring (not shown). This arrangement is such that, when the axial movement of the sectors is prevented, the axial movement of the rings causes a radial movement of the sectors. This is the case during closing, when the axially opposed faces of the sectors come back into contact with one another, and during opening, when the sectors are retained by the impressions of the tire sculpture.

Each clamping ring may include a circular cavity 711 and 721 respectively, in which a heat transfer fluid is made to flow by means of conduits 710 and 720.

Alternatively, a vulcanization device comprising a single set of sectors, integral with the lower pan for example, may be provided. In this case, a single clamping ring, moving integrally with the upper pan, is required. The axial movement of the clamping pan during closing causes the sectors to move radially.

In the embodiment of the invention illustrated in FIGS. 1 to 3, the lower and upper shells, and the lower and upper clamping rings, are fixed, respectively, to a lower heating plate 73 and an upper heating plate 74, each including an annular chamber 731 and 741 respectively, in which there flows a heat transfer fluid supplied by the conduits 730 and 740.

The lower heating plate 73 is connected to the pan through an annular reshaping envelope 3. The axially outer face of the lower heating plate 73 is in contact with the axially inner face of the reshaping envelope 3, and the axially outer face of the reshaping envelope 3 is in contact with the inner part of the lower pan 11.

The reshaping envelope includes an annular chamber 31 in which a pressurized fluid flows. The axially inner wall of the annular chamber can be moved axially by putting the annular chamber under a pressure P₂, and operates in a similar way to an annular actuator.

The reshaping envelope has an inside diameter D₁ and an outside diameter D₂, as shown in FIG. 2.

The reshaping envelope can be formed by the rigid walls of an annular chamber having one wall which is axially movable. Alternatively, if the pressure P₂ is not high, as is the case in most vulcanization devices, it is possible to use a flexible-walled chamber which inflates in the axial direction under the effect of the pressure P₂.

The projection of the volume of the reshaping envelope on a plane perpendicular to the axis XX′ delimits a surface with an area S₂. In the present case, S₂=π(D₂²−D₁²)/4.

It should be noted that, if the vulcanization device does not include a heating plate, the reshaping envelope is placed directly between the axially outer face of the lower shell and the base of the lower pan.

Preferably, a single reshaping envelope is provided, placed either between the axially outer part of the upper shell 52 of the mould and the base of the upper pan 12, or between the axially outer face of the lower shell 51 and the base of the lower pan 11, so as to retain a fixed geometric reference of the axial side of the pan facing the side where said reshaping envelope is placed.

A lower plate 91, movable axially by the action of a hub 90 with a diameter t₂, and an upper plate 82, also movable in the axial direction independently of the lower plate, by the action of a shaft 80 with a diameter t₁, are made to bear on the radially inner regions of the lower bead ring 61 and the upper bead ring 62 respectively. The shaft 80 slides axially in the hub 90. An O-ring 81 provides a seal between the shaft 80 and the hub 90. The axial movements of the lower and upper plates are produced by said operating means (not shown). Alternatively, it is possible to envisage a device in which the shaft 80 controlling the movement of the upper plate 82 penetrates into the upper part of the pan.

It may also prove useful to make the lower bead ring 61 integral with the lower plate 91, to enable the axial position of the tire P to be adjusted during the opening and closing phases.

With the vulcanization device configured in this manner, the inner walls of the lower plate 91 and of the upper plate 82, of the lower bead ring 61 and of the upper bead ring 62, of the lower shell 51 and of the upper shell 52, and of the lower sectors 41 and of the upper sectors 42 define, when the mould is in the closed position as shown in FIG. 2 or 3, an internal volume Vᵢ intended to receive a heat transfer fluid under a pressure P₁ during the vulcanization phase. A channel 900 is provided for the injection and discharge of said heat transfer fluid.

The inside diameter of the volume Vᵢ is denoted vᵢ (see FIG. 2).

The projection of the internal volume V, on a plane perpendicular to the axis XX′ delimits a surface area S₁. The calculation of this volume must allow for the cross section S₃ of the shaft 80. In the case to which the present description refers, S₁=π(vᵢ²−t₂²)/4.

If the shaft 80 does not pass through the internal volume Vᵢ, it is not necessary to subtract the cross section S₃ of said shaft in order to determine the cross section S₁.

It is frequently advantageous to connect the radially outer circumferences of the lower and upper plates with a flexible resilient sealing membrane B, so as to isolate the radially inner wall of the tire P from the fluid flowing in the internal volume Vᵢ. The calculation of the surface area S₁ remains unchanged.

FIG. 2 shows the vulcanization device in the closed and locked position before the pressurization of the heat transfer fluid inside the volume Vᵢ.

The mechanical clearances between the lower and upper pans 11 and 12 respectively and the locking means 2, and between the different parts of the mould, are identified by the letter “j”. These clearances tend to increase during the pressurization of the fluid in the internal volume Vi, thus giving rise to undesirable movements of the mould parts with respect to one another.

In order to eliminate these movements, it is proposed, according to the invention, that the geometry of the surfaces S₁ and S₂ be carefully defined. For this purpose, it is advisable to ensure, by adjusting the pressure P₂ for example, that the product of the pressure P₁ and the surface area S₁ is less than the product of the surface area S₂ and the pressure P₂. The axial force exerted by the movable wall of the reshaping envelope will then be greater than the axial component of the forces created by the pressure in the volume Vᵢ. Thus the mechanical clearances “j” are eliminated, as illustrated in FIG. 3.

It is possible to obtain further benefit from this arrangement according to the invention. In particular, supplementary clamping of the mould parts can be provided by ensuring that the force exerted by the wall of the reshaping envelope 3 is much greater than the force exerted by the pressure in the volume Vᵢ. The pressure P₂ can be increased as much as necessary for this purpose. However, it should be noted that this embodiment requires the connection of the housing to a supplementary hydraulic source of a fluid at a specified pressure P₂, in order to supply the reshaping envelope.

Additionally, in a first advantageous embodiment the surface area S₂ is made to be greater, or much greater, than the surface area S₁. In this case, the heat transfer fluid can be used to fill the reshaping envelope. The pressure P₂ may then be equal to the pressure P₁, while maintaining the desired inequality of the axial forces.

If necessary, the means for introducing the heat transfer fluid into the reshaping envelope can be adapted in order to control the internal volume Vi and the volume of the reshaping envelope independently, with particular care being taken in cases in which the heat transfer fluid is likely to change phase when surrendering its heat.

Because of the small volume of the reshaping envelope, it is possible to use only a very small part of the heat transfer fluid.

In another advantageous embodiment, as illustrated in the device to which the present description refers, the clamping rings can be made integral with the plates 73 and 74 supporting the shells 51 and 52. In this configuration, the additional axial clamping induced by the reshaping envelope 3 on the clamping rings 71 and 72 enables the radial clamping of the sectors to be increased.

Alternatively, it is possible to provide a first reshaping envelope, to compensate the axial opening forces of the mould parts, and a second reshaping envelope, independent of the first and placed between the clamping rings and the pan to create a supplementary radial clamping force on the sectors.

It should also be noted that it is no longer necessary to adapt the locking means 2 for keeping the lower and upper pans in the closed position in order to provide sufficient clamping to pre-stress the mould parts so that they can withstand the effects of the pressure. The forces required to activate this closing means are reduced, thus making this device lighter and more efficient.

1. A device for vulcanizing a tire, comprising a cylindrical vulcanization housing with an axis, formed by a lower pan and an upper pan which are movable axially with respect to one another, and means for locking the lower pan and upper pan, these means being adapted to keep said lower and upper pans in the closed position during vulcanization, and delimiting an enclosure containing:
a mould whose inner walls are intended to come into contact with the tire, and a lower plate and an upper plate which come to bear, respectively, on the radially inner regions of the mould parts which are intended to mould the lower bead and the upper bead of said tire when the pan is in the closed position,
in such a way that, when the pan is in the closed position, the inner walls of the mould and of the lower and upper plates delimit a closed internal volume intended to receive a heat transfer fluid at a pressure P₁, the projection of said internal volume on a plane perpendicular to the axis forming a surface whose area is S1,
wherein a reshaping envelope, configured to receive a fluid at a pressure P₂ and comprising a wall which is movable axially under the action of said fluid, is positioned axially between the axially outer walls of the mould parts and the vulcanization pan, the projection of said volume of said reshaping envelope on a plane perpendicular to the axis delimiting a surface with an area S₂, such that S₂*P₂ is greater than S₁*P₁, in such a way that, when the device is locked and pressurized, the movable wall exerts on the mould parts an axial force greater than the resultant of the axial forces which are exerted by the heat transfer fluid on the mould parts and tend to cause the axial opening of the parts of said mould.

2. The device according to claim 1, wherein the walls of the reshaping envelope are formed by a flexible membrane with a surface area S₂.

3. The device according to claim 1, wherein the walls of the reshaping envelope are formed by rigid walls forming an annular chamber in which a movable wall with a surface area S₂ moves axially.

4. The device according to claim 1, wherein the area of the surface S₂ is greater than the area of the surface Sᵢ.

5. The device according to claim 4, wherein the fluid is introduced into the reshaping envelope at a pressure P₂ identical to the pressure P₁ of the heat transfer fluid introduced into the internal volume.

6. The device according to claim 5, wherein the heat transfer fluid and the fluid introduced into the reshaping envelope are the same.

7. The device according to claim 1, wherein the mould comprises:
a lower shell and bead ring and an upper shell and bead ring, intended to mould the sidewalls and beads of the tire, and adapted to move towards each other axially,
a plurality of circularly distributed sectors, carrying the impression intended to mould the tread and adapted to be moved radially and, when the pan is in the closed position, to come into contact with the lower and upper shells as the segments move in the radially inward direction.

8. The device according to claim 7, wherein the sectors move radially under the action of at least one circular clamping ring, which moves integrally with the lower pan and/or the upper pan, and which interacts with the radially outer faces of said sectors.

9. The device according to claim 8, wherein the reshaping envelope is also positioned axially between the pan and the axially outer face of a ring, in such a way that the axial force exerted by the movable wall of the reshaping envelope on said ring when the fluid contained by said reshaping envelope is brought to the pressure P₂ exerts an additional radial clamping force on said sectors.

10. The device according to claim 9, wherein a heating plate carries a clamping ring, a shell and a bead ring, and in which the reshaping envelope is interposed between the axially outer wall of the heating plate and the pan.

11. The device according to claim 1, wherein a flexible resilient sealing membrane of substantially cylindrical shape is fixed by its two axial edges to the lower plate and the upper plate so as to be interposed between the inner surface of the tire and the heat transfer fluid.

12. The device according to claim 1, wherein the upper plate is carried by an operating shaft whose cross section perpendicular to the axis has an area S₃, and which passes through the internal volume intended to receive the heat transfer fluid, in such a way that the projection on a plane perpendicular to the axis of the internal volume containing the pressurized heat transfer fluid is decreased by the amount of the cross section S₃.
